(19) United States
(12) Patent Application Publication
(10) Pub. No.: US 2024/0075999 A1
(43) Pub. Date: Mar. 7, 2024

(54) DYNAMIC WEIGHT SHIFTING FOR VEHICLES

(71) Applicant: Owen Yu Hin Lai, Bellevue, WA (US)

(72) Inventor: Owen Yu Hin Lai, Bellevue, WA (US)

(21) Appl. No.: 17/938,919

(22) Filed: Sep. 6, 2022

(51) Int. Cl. B62D 63/04; B60L 50/60

(52) U.S. Cl. CPC B62D 63/04; B60L 50/66

(57) ABSTRACT

A system for dynamically shifting a weight of a component of a vehicle, includes: a sensor configured to sense a condition during operation of the vehicle; a processing unit configured to generate a control signal after the sensor has sensed the condition; and a positioning device configured to move the component of the vehicle based on the control signal received from the processing unit; wherein the positioning device is configured to move the component of the vehicle by a distance that is sufficient to change a center of mass of the vehicle by at least 6 inches.

### FIELD

The field relates to devices and methods for shifting a weight of a component in a vehicle, and more specifically, to devices and method for shifting a battery weight dynamically during operation of a vehicle.

### BACKGROUND

A vehicle normally has a center of mass that remains fixed or that does not vary significantly during use of the vehicle. For example, a center of mass of a vehicle may vary slightly due to a varying weight of a driver, different passengers' weights, positioning of passengers, weights and positioning of objects stored in the trunk/compartment, or any combination of the foregoing. In the case in which the vehicle is a gasoline vehicle, the center of mass of the vehicle may also vary slightly due to a varying amount of gasoline in the gas tank. However, such slight varying of center of mass may not be significant enough to cause a noticeable change in the driving characteristic of the vehicle. Also, such varying of center of mass of the vehicle may not correspond with a desirable driving characteristic of the vehicle to be achieved. For example, if a majority of the passengers' weight is in the front of the vehicle, this may shift of the center of mass slightly in the forward direction. However, such configuration may not be desirable if the driver wants to perform an acceleration maneuver.

### SUMMARY

A weight shifting system for a vehicle is described herein. The weight shifting system is configured to move a component of a vehicle to change a center of mass of the vehicle. In some cases, the center of mass of the vehicle is changed by an amount that is sufficient to effect a desirable change in driving characteristic of the vehicle.

A system for dynamically shifting a weight of a component of a vehicle, includes: a sensor configured to sense a condition during operation of the vehicle; a processing unit configured to generate a control signal after the sensor has sensed the condition; and a positioning device configured to move the component of the vehicle based on the control signal received from the processing unit; wherein the positioning device is configured to move the component of the vehicle by a distance that is sufficient to change a center of mass of the vehicle by at least 6 inches.

Optionally, the weight of the component is at least 50 lbs.

Optionally, the positioning device is configured to move the component of the vehicle by at least 12 inches.

Optionally, the positioning device is configured to move the component of the vehicle by a distance that is sufficient to change a driving characteristic of the vehicle.

Optionally, the component comprises a battery for the vehicle, and wherein the positioning device is coupled to the battery and is configured to move the battery based on the control signal.

Optionally, the battery is configured to power a motor of the vehicle, and wherein the positioning device is configured to move the battery while the battery is electrically coupled to the motor of the vehicle.

Optionally, the sensor is configured to sense an acceleration of the vehicle, and wherein the processing unit is configured to generate the control signal to operate the positioning device based on the sensed acceleration of the vehicle.

Optionally, the sensor is configured to sense a deceleration of the vehicle, and wherein the processing unit is configured to generate the control signal to operate the positioning device based on the sensed deceleration of the vehicle.

Optionally, the sensor is configured to sense a turning of the vehicle, and wherein the processing unit is configured to generate the control signal to operate the positioning device based on the sensed turning of the vehicle.

Optionally, the positioning device is configured to translate the component of the vehicle along a trajectory that is parallel to a longitudinal axis of the vehicle.

Optionally, the processing unit is configured to generate the control signal to operate the positioning device to move the component of the vehicle in a rearward direction during or before an acceleration of the vehicle, and/or while or before the vehicle is traveling downhill.

Optionally, the processing unit is configured to generate the control signal to operate the positioning device to move the component of the vehicle in a forward direction during or before a deceleration of the vehicle, and/or while or before the vehicle is traveling uphill.

Optionally, further comprising a user control configured to generate an output signal, wherein the sensor is configured to sense the output signal as the condition during the operation of the vehicle.

Optionally, the user control is operable to cause the positioning device to move the component of the vehicle in a first direction during a first mode of operation.

Optionally, the user control is operable to cause the positioning device to move the component of the vehicle in a second direction during a second mode of operation, the second direction being opposite from the first direction.

Optionally, the system further includes a first linear gear coupled to the component.

Optionally, the system further includes a first pinion operatively and moveably coupled to the first linear gear.

Optionally, the system further includes a second linear gear coupled to the component.

Optionally, the system further includes a first pinion operatively and moveably coupled to the first linear gear, and a second pinion operatively and moveably coupled to the second linear gear.

A method of dynamically shifting a weight of a component of a vehicle, includes: sensing a condition by a sensor during operation of the vehicle; generating a control signal, by a processing unit, after the sensor has sensed the condition; and moving, by a positioning device, the component of the vehicle based on the control signal received from the processing unit; wherein the component of the vehicle is moved by a distance that is sufficient to change a center of mass of the vehicle by at least 6 inches.

Optionally, in the method, the weight of the component is at least 50 lbs.

Optionally, in the method, the component of the vehicle is moved by the positioning device by at least 12 inches.

Optionally, in the method, the component of the vehicle is moved by the positioning device by a distance that is sufficient to change a driving characteristic of the vehicle.

Optionally, in the method, the component comprises a battery for powering a motor of the vehicle, and wherein the battery is moved by the positioning device based on the control signal.

Optionally, in the method, the battery is configured to power a motor of the vehicle, and wherein the battery is moved by the positioning device while the battery is electrically coupled to the motor of the vehicle.

Optionally, in the method, the sensor is configured to sense an acceleration of the vehicle, and the control signal is generated by the processing unit to operate the positioning device based on the sensed acceleration of the vehicle.

Optionally, in the method, the sensor is configured to sense a deceleration of the vehicle, and the control signal is generated by the processing unit to operate the positioning device based on the sensed deceleration of the vehicle.

Optionally, in the method, the sensor is configured to sense a turning of the vehicle, and the control signal is generated by the processing unit to operate the positioning device based on the sensed turning of the vehicle.

Optionally, in the method, the act of moving the component comprises translating the component of the vehicle along a trajectory that is parallel to a longitudinal axis of the vehicle.

Optionally, in the method, the component of the vehicle is moved in a rearward direction during or before an acceleration of the vehicle.

Optionally, in the method, the component of the vehicle is moved in a forward direction during or before a deceleration of the vehicle.

Optionally, the method further includes generating an output signal by a user control, wherein the act of sensing the condition comprises sensing the output signal during the operation of the vehicle.

Optionally, in the method, the user control is operable to cause the positioning device to move the component of the vehicle in a first direction during a first mode of operation.

Optionally, in the method, the user control is operable to cause the positioning device to move the component of the vehicle in a second direction during a second mode of operation, the second direction being opposite from the first direction.

Optionally, in the method, the component is coupled to a first straight gear rack.

Optionally, in the method, the act of moving the component comprises operating a first pinion that is operatively and moveably coupled to the first straight gear rack.

Optionally, in the method, the component is coupled to a second straight gear rack.

Optionally, in the method, the act of moving the component comprises operating a first pinion that is operatively and moveably coupled to the first straight gear rack, and/or operating a second pinion that is operatively and moveably coupled to the second straight gear rack.

Other and further aspects and features will be evident from reading the following detailed description.

### BRIEF DESCRIPTION OF THE DRAWINGS

The drawings illustrate the design and utility of embodiments, in which similar elements are referred to by common reference numerals. In order to better appreciate how advantages and objects are obtained, a more particular description of the embodiments will be described with reference to the accompanying drawings. Understanding that these drawings depict only exemplary embodiments and are not therefore to be considered limiting in the scope of the claimed invention.

FIG. 1 illustrates a top view of a vehicle that includes a weight shifting system in accordance with some embodiments, particularly showing the weight shifting system placing a component of the vehicle in a forward position.

FIG. 2 illustrates a side view of the vehicle that includes the weight shifting system of FIG. 1.

FIG. 3 illustrates a top view of the vehicle of FIG. 1, particularly showing the weight shifting system placing the component of the vehicle in a rear position.

FIG. 4 illustrates a side view of the vehicle that includes the weight shifting system of FIG. 3.

FIG. 5 illustrates a top view of the weight shifting system of FIG. 1, particularly showing the weight shifting system having a linear gear and a pinion.

FIG. 6 illustrates a side view of the weight shifting system of FIG. 5.

FIG. 7 illustrates the weight shifting system of FIG. 5, particularly showing the weight shifting system includes a bearing system.

FIG. 8 illustrates a block diagram of a processing unit and a sensor of a weight shifting system.

FIG. 9 illustrates a method in accordance with some embodiments.

FIG. 10 illustrates a specialized processing system in accordance with some embodiments.

### DESCRIPTION OF THE EMBODIMENTS

Various embodiments are described hereinafter with reference to the figures. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages of the invention shown. An aspect or an advantage described in conjunction with a particular embodiment is not necessarily limited to that embodiment and can be practiced in any other embodiments even if not so illustrated or if not so explicitly described.

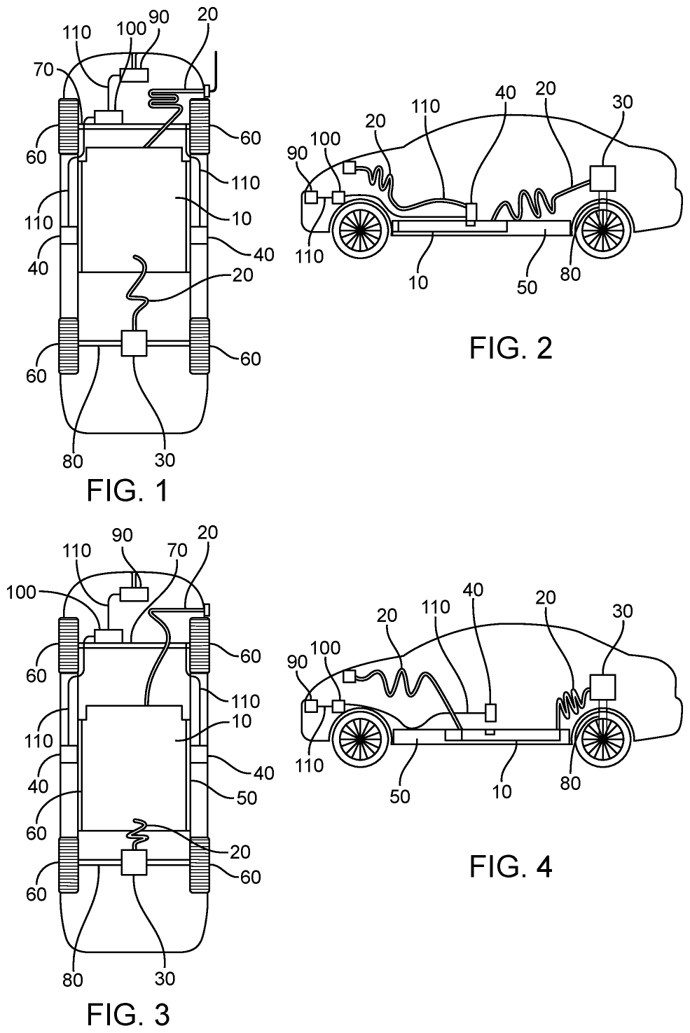

FIG. 1 illustrates a top view of a vehicle 2 that includes a weight shifting system 4 in accordance with some embodiments.

In the illustrated embodiments, the vehicle 2 is an electric or hybrid vehicle, and includes a battery 10 for powering a motor 30 of the vehicle 2. As shown in the figure, the battery 10 is electrically coupled to the motor 30 via a high voltage cabling 20. The high voltage cabling 20 is configured to transmit battery power from the battery 10 to the motor 30 in order to power the motor 30. In some embodiments, the motor 30 is configured to rotate front and/or rear wheels 60 via front axel 70 and rear axel 80. In other embodiments, the motor may be configured to rotate the front and/or rear wheels 60 directly without utilizing the axel 70 and/or the axel 80. In the above embodiments, the vehicle 2 is illustrated as having one motor 30. In other embodiments, the vehicle 2 may have two motors 30 configured to respectively rotate the front and rear wheels 60. In further embodiments, the vehicle 2 may have four motors 30 configured to respective rotate the four wheels 60.

The weight shifting system 4 is for dynamically shifting a weight of a component (e.g., the battery 10) of the vehicle 2. The weight shifting system 4 includes a sensor 90 configured to sense a condition during operation of the vehicle 2; a processing unit 100 configured to generate a control signal after the sensor 90 has sensed the condition; and a positioning device 102 configured to move the battery 10 of the vehicle 2 based on the control signal received from the processing unit 100. The processing unit 100 is coupled to the positioning device 102 via a wiring 110, which is configured to transmit control signal(s) from the processing unit 100 to the positioning device 102 to operate the positioning device 102.

The positioning device 102 is configured to move the battery 10 while the battery 10 is electrically coupled to the motor 30 of the vehicle 2. In some cases, the vehicle 2 may include multiple batteries for powering the motor 30 of the vehicle 2, and the battery 10 may be one or more of the batteries. In other cases, the battery 10 may be the entire battery system (that includes multiple battery units) of the vehicle 2.

In the illustrated embodiments, the positioning device 102 is configured to move the battery 10 of the vehicle 2 by a distance that is sufficient to change a center of mass of the vehicle 2 by at least 6 inches, and more preferably by at least 12 inches, and even more preferably by at least 24 inches, and even more preferably by at least 36 inches.

In some cases, the weight of the battery 10 being moved by the positioning device 102 is at least 50 lbs. In other cases, the weight of the battery being moved by the positioning device 102 may be more than 50 lbs (e.g., more than: 60 lbs, 70 lbs, 80 lbs, 90 lbs, 100 lbs, 110 lbs, 120 lbs, 130 lbs, 140 lbs, 150 lbs, 160 lbs, 170 lbs, 180 lbs, 190 lbs, 200 lbs, 250 lbs, 300 lbs, 350 lbs, 400 lbs, etc.).

In some embodiments, the positioning device 102 is configured to move the battery 10 of the vehicle 2 by at least 12 inches, and more preferably by at least 24 inches, and even more preferably by at least 36 inches.

In the illustrated embodiments, the positioning device is configured to move the battery 10 of the vehicle 2 by a distance that is sufficient to change a driving characteristic of the vehicle 2.

In the illustrated embodiments, the weight shifting system 4 is configured to dynamically place the battery 10 at different positions relative to the vehicle 2 during different modes of operation. For example, the different positions may be at least two different positions, such as a forward position and a rear position.

In some cases, the processing unit 100 is configured to generate a control signal to operate the positioning device 102 to move a component (e.g., battery 10) of the vehicle 2 in a forward direction during or before a deceleration of the vehicle 2. As shown in FIG. 1, the weight shifting system 4 has placed the battery 10 of the vehicle 2 in a forward position. FIG. 2 illustrates a side view of the vehicle 2 that includes the weight shifting system 4 of FIG. 1, particularly showing the weight shifting system 4 having placed the battery 10 of the vehicle 2 in the forward position. Placing the battery 10 of the vehicle 2 in the forward position may be desirable in some driving situations, such as when the vehicle 2 is decelerating or traveling uphill.

The processing unit 100 is also configured to generate a control signal to operate the positioning device 102 to move the component (e.g., battery 10) of the vehicle 2 in a rearward direction during or before an acceleration of the vehicle 2. FIG. 3 illustrates a top view of the vehicle of FIG. 1, particularly showing the weight shifting system placing the component of the vehicle in a rear position. FIG. 4 illustrates a side view of the vehicle 2 that includes the weight shifting system 4, particularly showing the weight shifting system 4 having placed the battery 10 of the vehicle in the rear position. Placing the battery 10 of the vehicle 2 in the rear position may be desirable in some driving situations, such as when the vehicle 2 is accelerating or traveling downhill. In some cases, placing the battery 10 of the vehicle 2 in the rear position may also be desirable during a turn maneuver. This is because increasing the weight in the back of the vehicle 2 is better for car's handling.

In some cases, the sensor 90 of the weight shifting system 4 is configured to sense an acceleration of the vehicle 2, and the processing unit 100 is configured to generate the control signal to operate the positioning device 102 based on the sensed acceleration of the vehicle 2. Alternatively or additionally, the sensor 90 of the weight shifting system 4 is configured to sense a deceleration of the vehicle 2, and the processing unit 100 is configured to generate the control signal to operate the positioning device 102 based on the sensed deceleration of the vehicle 2. Alternatively or additionally, the sensor 90 of the weight shifting system 4 may be configured to sense a turning of the vehicle 2, and the processing unit 100 is configured to generate the control signal to operate the positioning device 102 based on the sensed turning of the vehicle 2. By means of non-limiting examples, the turning of the vehicle 2 may be sensed using a gyroscope, a yaw sensor, a yaw rate sensor, centripetal force sensor, centrifugal force sensor, steering wheel-turning sensor, etc. Thus, the sensor 90 may include one or more of the above sensors.

In some cases, the weight shifting system 4 may include a user control that generates an output signal in response to the user control being operated by the driver. In such cases, the sensor 90 of the weight shifting system 4 is configured to sense the output signal from a user control as the condition during the operation of the vehicle. Based on the sensed condition (the output signal from the user control), the processing unit 100 then operates the positioning device 102 to move the battery 10.

In some embodiments, the user control is operable to cause the positioning device 102 to move the battery 10 of the vehicle 2 in a first direction during a first mode of operation. The user control is also operable to cause the positioning device 102 to move the battery 10 of the vehicle 2 in a second direction during a second mode of operation, the second direction being opposite from the first direction. The first direction may be a forward direction to place the battery 10 at a forward position. This may be desirable before or during a deceleration maneuver, and/or while or before the vehicle 2 is travelling uphill. The second direction may be a rearward direction to place the battery 10 at a rear position. This may be desirable before or during an acceleration maneuver, and/or while or before the vehicle is travelling downhill. In some cases, dynamically moving the battery in a rearward direction is also desirable during or before a turning maneuver. This is because increasing the weight in the back of the vehicle is better for car's handling.

It should be noted that the user control is not limited to be operable to place the battery 10 in only two positions, and that the user control may be configured to be operable to place the battery 10 in more than two positions. For example, in other embodiments, the user control may be operable to place the battery 10 in a forward position, a rear position, and a center position.

In one implementation, the user control may be a rotatable knob that can be rotated to two or more positions to control the positioning device 102 to place the battery 10 in two or more respective positions. In another implementation, the user control may be a slider bar that can be translated to two or more positions to control the positioning device 102 to place the battery 10 in two or more respective positions. In a further implementation, the user control may be two or more buttons that can be pressed to control the positioning device 102 to place the battery 10 in two or more respective positions.

In still a further implementation, the user control may be a touchscreen with one or more graphical elements. The graphical element(s) is configured to allow the driver to control the positioning device 102 to place the battery 10 in two or more respective positions. For example, the graphical element(s) may be comprise an image or graphical representation of a vehicle displayed in a screen. The graphical element(s) may also include a graphical object representing a component (e.g., the battery 10) being moved by the positioning device 102. The graphical object may be displayed over the image or graphical representation of the vehicle. The user may move the graphical object relative to the image or graphical representation of the vehicle to control the positioning device 102. The relative positioning between the graphical object (representing the battery 10) and the image/graphical representation of the vehicle, corresponds with the desirable relative positioning between the battery 10 and the vehicle 2.

The processing unit 100 may be implemented using hardware and/or software. By means of non-limiting examples, hardware may be an integrated circuit, a processor (e.g., general purpose processor, signal processor, FPGA, etc.), hardware components (e.g., transistor, resistor, etc.) or any combination of the foregoing.

It should be noted that the weight shifting system 4 is not limited to the examples described, and that the weight shifting system 4 may have other configurations in other embodiments. For example, in other embodiments, the weight shifting system 4 may be configured to place the battery 10 of the vehicle 2 at more than two different positions relative to the vehicle 2 in more than two modes of operations. In some embodiments, the processing unit 100 may be configured to determine an optimum position for placement of the battery 10, and dynamically control the positioning device 102 to position the battery 10 to the determined optimum position during operation of the vehicle 2 by the driver.

Also, instead of the battery 10, in other embodiments, the weight shifting system 4 may be configured to move other component(s) of the vehicle 2. By means of non-limiting examples, the weight shifting system 4 may be configured to move a spare tire of the vehicle 2, a seat of the vehicle 2, a storage compartment of the vehicle 2, an engine of the vehicle 2 (in the embodiments in which the vehicle 2 is a gasoline vehicle or hybrid vehicle), etc.

In the above embodiments, the weight shifting system 4 has been described as moving the battery 10 along a trajectory that is parallel to a longitudinal axis of the vehicle 2, wherein the movement trajectory of the battery is rectilinear. In other embodiments, the weight shifting system 4 may be configured to move the battery 10 along a non-rectilinear path, such as along a curvilinear path, or a step-wise path. Also, in other embodiments, the weight shifting system 4 may be configured to move the battery 10 along a path that is non-parallel to the longitudinal axis of the vehicle 2. Furthermore, in other embodiments, the weight shifting system 4 may be configured to move the battery 10 of the vehicle 2 vertically to change an elevation of the battery 10, and/or transversely (e.g., left or right).

In some embodiments, the movement of the component (e.g., the battery 10) relative to the vehicle 2 may be achieved using a gear system that includes one or more linear gear and one or more pinions.

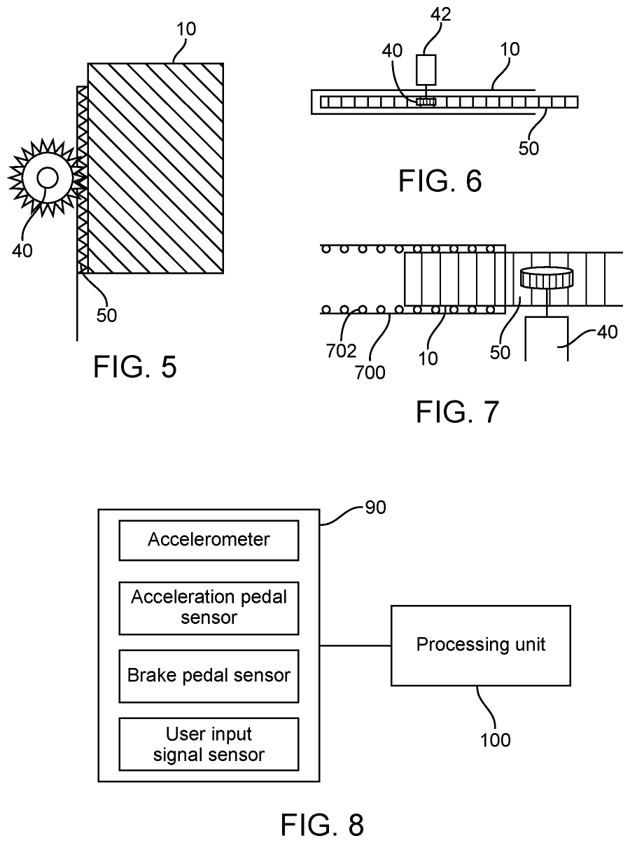

FIG. 5 illustrates a top view of the weight shifting system 4 of FIG. 1, particularly showing the weight shifting system 4 having a first linear gear 50 and a first pinion 40. As shown in the figure, the first linear gear 50 is fixedly coupled to the battery 10. The first pinion 40 is operatively and moveably coupled to the first linear gear 50. In some cases, the processing unit 100 is configured to generate a control signal in response to a sensed condition to operate a positioner motor 42 (shown in FIG. 6) to turn the first pinion 40. This will cause the first linear gear 50 to translate. Since the battery 10 is fixedly coupled to the first linear gear 50, the translation of the first linear gear 50 will cause the battery to translate.

Optionally, the weight shifting system 4 may further include a second linear gear coupled to the component (e.g., the battery 10). The first and second linear gears may be coupled to the battery 10 on opposite sides of the battery 10 in some embodiments. In such cases, the weight shifting system 4 may include the first pinion 40 operatively and moveably coupled to the first linear gear, and a second pinion operatively and moveably coupled to the second linear gear. During use, the processing unit 100 is configured to generate a control signal in response to a sensed condition to operate a first positioner motor to turn the first pinion 40 and/or to operate a second positioner motor to turn the second pinion. This will cause the first linear gear 50 and/or the second linear gear to translate. Since the battery 10 is fixedly coupled to the first linear gear 50 and the second linear gear, the translation of the first linear gear 50 and/or the second linear gear will cause the battery 10 to translate.

In some cases, the component (e.g., the battery 10) being moved by the positioning device 102 may be moveably supported by a bearing system. FIG. 7 illustrates the weight shifting system 4 of FIG. 5, particularly showing the weight shifting system 4 having a bearing system 700 for moveably supporting the battery 10. The bearing system 700 includes a plurality of bearings 702 configured to moveably support the battery 10.

In the above embodiments, the sensor 90 is described as being configured to sense an acceleration and/or deceleration of the vehicle 2. In one implementation, the sensor 90 may include one or more accelerometers configured to sense an acceleration and/or deceleration of the vehicle 2. Alternatively, or additionally, the sensor 90 may include one or more additional sensing units configured to sense other condition(s) related to an operation of the vehicle 2. For example, the sensor 90 may include an acceleration pedal sensor configured to sense a depression of the acceleration pedal, and/or a brake pedal sensor configured to sense a depression of the brake pedal. In some cases, the sensed depression of the acceleration pedal may be utilized by the processing unit 100 to corroborate or confirm an acceleration sensed by the accelerometer. Similarly, the sensed depression of the brake pedal may be utilized by the processing unit 100 to corroborate or confirm a deceleration sensed by the accelerometer. Alternatively, the sensed depression of the acceleration pedal or the sensed depression of the brake pedal may be utilized as the only sensed condition by the processing unit 100 for operating the positioning device 102. Thus, as used in this specification, the term “sensor” is not limited to only one single sensing unit, and may include multiple sensing units that are configured to sense different conditions.

Also, as discussed, in some embodiments, the weight shifting system 4 may include a user control for allowing the user to selectively place a component (e.g., the battery 10) of the vehicle 2 at a desired position. In such cases, the sensor 90 is configured to sense the input from the user control, and may not include other sensing units (e.g., the sensor 90 may not include the accelerometer, the acceleration pedal sensor, and the brake pedal sensor). Also, in such cases, the processing unit 100 is configured to use the sensed user input as the only condition for operating the positioning device 102.

In further embodiments, the sensor 90 may include the user control as well as one or more sensing units, such as an accelerometer, an acceleration pedal sensor, a brake pedal sensor, or any combination of the foregoing. FIG. 8 illustrates a block diagram of the processing unit 100 and the sensor 90 of the weight shifting system 4, particularly showing the sensor 90 including an accelerometer, an acceleration pedal sensor, a brake pedal sensor, and a user input signal sensor.

In one mode of operation, the user input signal sensor is configured to sense a control signal from a user control, and in response to the sensed control signal, the processing unit 100 then operates the positioning device 102 to move the component (e.g., the battery 10) of the vehicle.

In another mode of operation, the accelerometer is configured to sense an acceleration or a deceleration of the vehicle 2, and in response to the sensed acceleration or deceleration, the processing unit 100 then operates the positioning device 102 to move the component (e.g., the battery 10) of the vehicle. Optionally, sensed depression of the acceleration pedal by the acceleration pedal sensor and/or sensed depression of the brake pedal by the brake pedal sensor may be utilized by the processing unit 100 to confirm whether the vehicle 2 is accelerating or decelerating.

Alternatively, the processing unit 100 may utilized the sensed depression of the acceleration pedal by the acceleration pedal sensor and/or the sensed depression of the brake pedal by the brake pedal sensor, as the primary sensed condition. In response to such primary sensed condition, the processing unit 100 then operates the positioning device 102 to move the component of the vehicle. Optionally, the sensed acceleration or deceleration by the accelerometer may be utilized by the processing unit to confirm whether the vehicle 2 is accelerating or decelerating.

In a further mode of operation, the accelerometer and/or the pedal sensor(s) (e.g., the acceleration pedal sensor and/or the brake pedal sensor) may be configured to detect an acceleration or deceleration of the vehicle 2. However, before the processing unit 100 generates a control signal to operate the positioning device 102 based on the sensed acceleration or sensed deceleration, the processing unit 100 checks to see if the driver has operated the user control to allow movement of the component (e.g., the battery 10) by the positioning device 102. If the user control has not been operated to allow movement of the component of the vehicle 2, then the processing unit 100 will not generate a control signal to operate the positioning device 102 to move the component of the vehicle 2. On the other hand, if the user control has been operated to allow movement of the component of the vehicle 2, then the processing unit 100 will generate a control signal to operate the positioning device 102 to move the component of the vehicle 2. In one implementation, the processing unit 100 includes logic for checking whether both conditions, (1) acceleration/deceleration sensed, and (2) user control has been operated to allow movement of the component of the vehicle 2, are met. If so, then the processing unit 100 will generate the control signal to operate the positioning device 102 to move the component of the vehicle 2 in accordance with the sensed acceleration/deceleration. If one or both of the above conditions (1), (2) are not met, then the processing unit 100 will not generate the control signal to operate the positioning device 102.

Methods

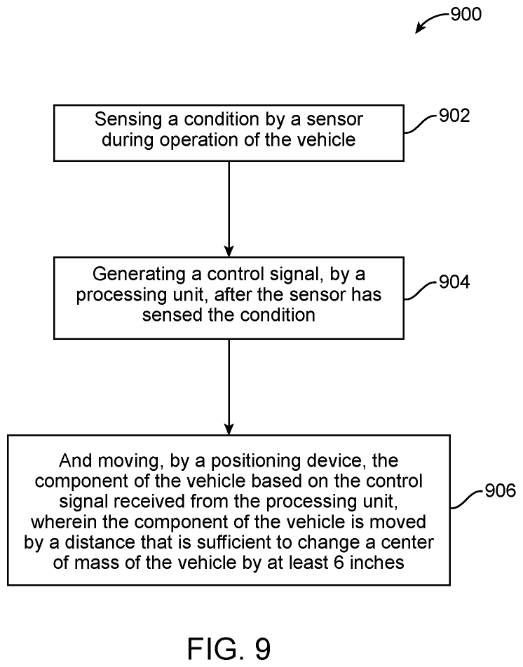

FIG. 9 illustrates a method 900 of dynamically shifting a weight of a component of a vehicle 2 performed by the weight shifting system 4 in accordance with some embodiments. The method 900 includes: sensing a condition by a sensor during operation of the vehicle (item 902); generating a control signal, by a processing unit, after the sensor has sensed the condition (item 904); and moving, by a positioning device, the component of the vehicle based on the control signal received from the processing unit, wherein the component of the vehicle is moved by a distance that is sufficient to change a center of mass of the vehicle by at least 6 inches (item 906).

Optionally, in the method 900, the weight of the component is at least 50 lbs.

Optionally, in the method 900, the component of the vehicle 2 is moved by the positioning device by at least 12 inches.

Optionally, in the method 900, the component of the vehicle 2 is moved by the positioning device by a distance that is sufficient to change a driving characteristic of the vehicle 2.

Optionally, in the method 900, the component comprises a battery 10 for powering a motor 30 of the vehicle 2, and wherein the battery 10 is moved by the positioning device 102 based on the control signal.

Optionally, in the method 900, the battery 10 is configured to power a motor 30 of the vehicle 2, and wherein the battery 10 is moved by the positioning device 102 while the battery 10 is electrically coupled to the motor 30 of the vehicle 2.

Optionally, in the method 900, the sensor 90 is configured to sense an acceleration of the vehicle 2, and the control signal is generated by the processing unit 100 to operate the positioning device 102 based on the sensed acceleration of the vehicle 2.

Optionally, in the method 900, the sensor 90 is configured to sense a deceleration of the vehicle 2, and the control signal is generated by the processing unit 100 to operate the positioning device 102 based on the sensed deceleration of the vehicle 2.

Optionally, in the method 900, the sensor 90 is configured to sense a turning of the vehicle 2, and the control signal is generated by the processing unit 100 to operate the positioning device 102 based on the sensed turning of the vehicle 2.

Optionally, in the method 900, the act of moving the component comprises translating the component of the vehicle 2 along a trajectory that is parallel to a longitudinal axis of the vehicle 2.

Optionally, in the method 900, the component of the vehicle 2 is moved in a rearward direction during or before an acceleration of the vehicle 2.

Optionally, in the method 900, the component of the vehicle 2 is moved in a forward direction during or before a deceleration of the vehicle 2.

Optionally, the method 900 further includes generating an output signal by a user control, wherein the act of sensing the condition comprises sensing the output signal during the operation of the vehicle 2.

Optionally, in the method 900, the user control is operable to cause the positioning device 102 to move the component of the vehicle 2 in a first direction during a first mode of operation.

Optionally, in the method 900, the user control is operable to cause the positioning device 102 to move the component of the vehicle 2 in a second direction during a second mode of operation, the second direction being opposite from the first direction.

Optionally, in the method 900, the component is coupled to a first straight gear rack.

Optionally, in the method 900, the act of moving the component comprises operating a first pinion that is operatively and moveably coupled to the first straight gear rack.

Optionally, in the method 900, the component is coupled to a second straight gear rack.

Optionally, in the method 900, the act of moving the component comprises operating a first pinion that is operatively and moveably coupled to the first straight gear rack, and/or operating a second pinion that is operatively and moveably coupled to the second straight gear rack.

Specialized Processing System

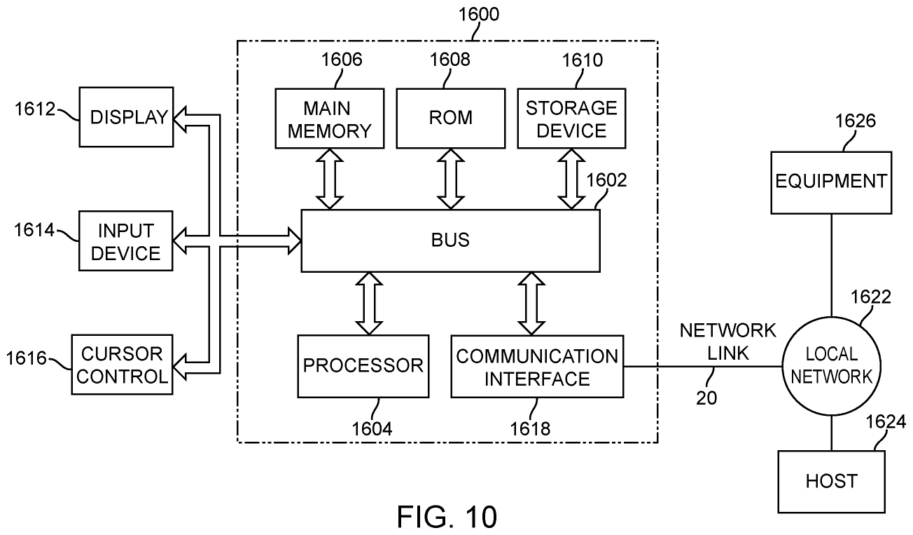

FIG. 10 illustrates a specialized processing system 1600 for implementing the processing unit 100, or a part of the processing unit 100, described herein.

Processing system 1600 includes a bus 1602 or other communication mechanism for communicating information, and a processor 1604 coupled with the bus 1602 for processing information. The processor system 1600 also includes a main memory 1606, such as a random access memory (RAM) or other dynamic storage device, coupled to the bus 1602 for storing information and instructions to be executed by the processor 1604. The main memory 1606 also may be used for storing temporary variables or other intermediate information during execution of instructions to be executed by the processor 1604. The processor system 1600 further includes a read only memory (ROM) 1608 or other static storage device coupled to the bus 1602 for storing static information and instructions for the processor 1604. A data storage device 1610, such as a magnetic disk or optical disk, is provided and coupled to the bus 1602 for storing information and instructions.

The processor system 1600 may be coupled via the bus 1602 to a display 1612, such as a screen or a flat panel, for displaying information to a user. An input device 1614, including alphanumeric and other keys, or a touchscreen, and/or any of other data capture devices (sensors), is coupled to the bus 1602 for communicating information and command selections to processor 1604. Another type of user input device is cursor control 1616, such as a 2D touchpad, a touchscreen, a trackball, or cursor direction keys for communicating direction information and command selections to processor 1604 and/or for controlling cursor movement on display 1612. This input device typically has two degrees of freedom in two axes, a first axis (e.g., x) and a second axis (e.g., y), that allows the device to specify positions in a plane. The input device 1614 and/or the cursor control device 1616 may be the same device in some embodiments. Also, the input device 1614 and/or the cursor control device 1616 may be any 2D input device or 3D input device.

In some embodiments, the processor system 1600 can be used to perform various functions described herein. According to some embodiments, such use is provided by processor system 1600 in response to processor 1604 executing one or more sequences of one or more instructions contained in the main memory 1606. Those skilled in the art will know how to prepare such instructions based on the functions and methods described herein. Such instructions may be read into the main memory 1606 from another processor-readable medium, such as storage device 1610. Execution of the sequences of instructions contained in the main memory 1606 causes the processor 1604 to perform the process steps described herein. One or more processors in a multi-processing arrangement may also be employed to execute the sequences of instructions contained in the main memory 1606. In alternative embodiments, hard-wired circuitry may be used in place of or in combination with software instructions to implement the various embodiments described herein. Thus, embodiments are not limited to any specific combination of hardware circuitry and software.

The term “processor-readable medium” as used herein refers to any medium that participates in providing instructions to the processor 1604 for execution. Such a medium may take many forms, including but not limited to, non-volatile media, volatile media, and transmission media. Non-volatile media includes, for example, optical or magnetic disks, SD disks, such as the storage device 1610. A non-volatile medium may be considered an example of non-transitory medium. Volatile media includes dynamic memory, such as the main memory 1606. A volatile medium may be considered an example of non-transitory medium. Transmission media includes cables, wire and fiber optics, including the wires that comprise the bus 1602. Transmission media can also take the form of acoustic or light waves, such as those generated during radio wave and infrared data communications.

Common forms of processor-readable media include, for example, hard disk, a magnetic medium, a CD-ROM, any other optical medium, a RAM, a PROM, and EPROM, a FLASH-EPROM, any other memory chip or cartridge, a carrier wave as described hereinafter, or any other medium from which a processor can read.

Various forms of processor-readable media may be involved in carrying one or more sequences of one or more instructions to the processor 1604 for execution. For example, the instructions may initially be carried on a storage of a remote computer or remote device. The remote computer or device can send the instructions over a network, such as the Internet. A receiving unit local to the processing system 1600 can receive the data from the network, and provide the data on the bus 1602. The bus 1602 carries the data to the main memory 1606, from which the processor 1604 retrieves and executes the instructions. The instructions received by the main memory 1606 may optionally be stored on the storage device 1610 either before or after execution by the processor 1604.

The processing system 1600 also includes a communication interface 1618 coupled to the bus 1602. The communication interface 1618 provides a two-way data communication coupling to a network link 1620 that is connected to a local network 1622. For example, the communication interface 1618 may be an integrated services digital network (ISDN) card to provide a data communication. As another example, the communication interface 1618 may be a local area network (LAN) card to provide a data communication connection to a compatible LAN. Wireless links may also be implemented. In any such implementation, the communication interface 1618 sends and receives electrical, electromagnetic or optical signals that carry data streams representing various types of information.

The network link 1620 typically provides data communication through one or more networks to other devices. For example, the network link 1620 may provide a connection through local network 1622 to a host computer 1624 or to equipment 1626. The data streams transported over the network link 1620 can comprise electrical, electromagnetic or optical signals. The signals through the various networks and the signals on the network link 1620 and through the communication interface 1618, which carry data to and from the processing system 1600, are exemplary forms of carrier waves transporting the information. The processing system 1600 can send messages and receive data, including program code, through the network(s), the network link 1620, and the communication interface 1618.

Also, as used in this specification, the term “signal” may refer to one or more signals. By means of non-limiting examples, a signal may include one or more data, one or more information, one or more signal values, one or more discrete values, etc.

Although particular features have been shown and described, it will be understood that they are not intended to limit the claimed invention, and it will be made obvious to those skilled in the art that various changes and modifications may be made without departing from the spirit and scope of the claimed invention. The specification and drawings are, accordingly to be regarded in an illustrative rather than restrictive sense. The claimed invention is intended to cover all alternatives, modifications and equivalents.

What is claimed:

1. A system for dynamically shifting a weight of a component of a vehicle, the system comprising:
a sensor configured to sense a condition during operation of the vehicle;
a processing unit configured to generate a control signal after the sensor has sensed the condition; and
a positioning device configured to move the component of the vehicle based on the control signal received from the processing unit;
wherein the positioning device is configured to move the component of the vehicle by a distance that is sufficient to change a center of mass of the vehicle by at least 6 inches.

2. The system of claim 1, wherein the weight of the component is at least 50 lbs.

3. The system of claim 1, wherein the positioning device is configured to move the component of the vehicle by at least 12 inches.

4. The system of claim 1, wherein the positioning device is configured to move the component of the vehicle by a distance that is sufficient to change a driving characteristic of the vehicle.

5. The system of claim 1, wherein the component comprises a battery for the vehicle, and wherein the positioning device is coupled to the battery and is configured to move the battery based on the control signal.

6. The system of claim 5, wherein the battery is configured to power a motor of the vehicle, and wherein the positioning device is configured to move the battery while the battery is electrically coupled to the motor of the vehicle.

7. The system of claim 1, wherein the sensor is configured to sense an acceleration of the vehicle, and wherein the processing unit is configured to generate the control signal to operate the positioning device based on the sensed acceleration of the vehicle.

8. The system of claim 1, wherein the sensor is configured to sense a deceleration of the vehicle, and wherein the processing unit is configured to generate the control signal to operate the positioning device based on the sensed deceleration of the vehicle.

9. The system of claim 1, wherein the sensor is configured to sense a turning of the vehicle, and wherein the processing unit is configured to generate the control signal to operate the positioning device based on the sensed turning of the vehicle.

10. The system of claim 1, wherein the positioning device is configured to translate the component of the vehicle along a trajectory that is parallel to a longitudinal axis of the vehicle.

11. The system of claim 1, wherein the processing unit is configured to generate the control signal to operate the positioning device to move the component of the vehicle in a rearward direction during or before an acceleration of the vehicle, and/or while or before the vehicle is traveling downhill.

12. The system of claim 1, wherein the processing unit is configured to generate the control signal to operate the positioning device to move the component of the vehicle in a forward direction during or before a deceleration of the vehicle, and/or while or before the vehicle is traveling uphill.

13. The system of claim 1, wherein further comprising a user control configured to generate an output signal, wherein the sensor is configured to sense the output signal as the condition during the operation of the vehicle.

14. The system of claim 13, wherein the user control is operable to cause the positioning device to move the component of the vehicle in a first direction during a first mode of operation.

15. The system of claim 13, wherein the user control is operable to cause the positioning device to move the component of the vehicle in a second direction during a second mode of operation, the second direction being opposite from the first direction.

16. The system of claim 1, further comprising a first linear gear coupled to the component.

17. The system of claim 16, further comprising a first pinion operatively and moveably coupled to the first linear gear.

18. The system of claim 16, further comprising a second linear gear coupled to the component.

19. The system of claim 18, further comprising a first pinion operatively and moveably coupled to the first linear gear, and a second pinion operatively and moveably coupled to the second linear gear.
